(19) United States
(12) Patent Application Publication
(10) Pub. No.: US 2008/0256967 A1
(43) Pub. Date: Oct. 23, 2008

(54) FITNESS FACTOR FOR AUTOMATICALLY ADJUSTING A VEHICLE HVAC SYSTEM

(75) Inventor: Bradley C. Errington, Bellefontaine, OH (US)

Correspondence Address: RANKIN, HILL & CLARK LLP, 38210 GLENN AVENUE, WILLOUGHBY, OH, 44094-7808, US

(73) Assignee: HONDA MOTOR CO., LTD., Tokyo (JP)

(21) Appl. No.: 11/738,031

(22) Filed: Apr. 20, 2007

(51) Int. Cl. B60H 1/32

(52) U.S. Cl. 62/244

(57) ABSTRACT

A vehicle climate control system with a seat position sensor and an occupant weight sensor. The seat position sensor and the occupant weight sensor communicate a seat position and a weight of a vehicle occupant to a controller. By determining the seat position, an occupant's relative size can be estimated. Thus, when the controller receives the occupant weight data and the seat position data, a fitness factor is determined. The fitness factor is a metric that combines the occupant weight and size into a single measurement to judge the occupant's fitness level. The fitness factor, either directly or indirectly is used to determine a temperature at outlet (TAO), which is then used to adjust an HVAC system so that comfortable cabin air conditions can be provided to occupants who have different fitness factors and thus different fitness levels without the occupants making manual changes to the HVAC system.

### BACKGROUND OF THE INVENTION

1. Field of the Invention

The present invention is directed toward a device and a method for automatically adjusting climate control settings based upon an individual's personal fitness.

2. Description of Related Art

In modern vehicles it is common to have a heating and cooling system (hereinafter “HVAC system”) for an occupant compartment (hereinafter “cabin”). The HVAC system provides warm and cool air to the cabin of the vehicle and allows occupants to select a set temperature for the cabin. Once the set temperature is selected, the HVAC system will provide heated or cooled air to adjust the cabin air conditions.

However, many factors can affect how comfortable the interior cabin air conditions feel to the vehicle occupant. For example, while the occupant may typically feel comfortable when the set temperature is 70° F. (21° C.), sun rays entering the cabin may cause the occupant to feel warmer than desired. Further, in order to feel comfortable, a large occupant may require a different set temperature than the set temperature of someone who is small in stature. If multiple occupants utilize the same vehicle at different times, and these occupants are of different body sizes, the set temperature may have to be adjusted after every occupant change since the individual's body size may result in the set temperature feeling too warm or too cold.

In order to adjust for these and other factors, additional sensors are typically installed in the vehicle. These sensors may include, for example, an ambient temperature sensor, a cabin temperature sensor, a relative humidity sensor, a glass temperature sensor, and a solar load sensor. After receiving signals from the sensors, a controller controls the HVAC system to adjust the cabin temperature. However, the addition of sensors to the vehicle is costly and complicated. Further, these sensors and the controller do not adjust the HVAC system based upon the occupant's physical fitness or body size.

Therefore, there exists a need in the art for an apparatus and method to use data from sensors already present in the vehicle to better control the cabin environment for occupants of different sizes and shapes.

### SUMMARY OF THE INVENTION

The present invention is directed toward an apparatus and method that provide a more comfortable cabin environment by adjusting the HVAC operation based upon occupant weight and seat position.

More specifically, the present invention includes an occupant weight sensor and an occupant position sensor that are adapted to measure an occupant's weight and a position of the seat. The occupant weight sensor is preferably already present in the vehicle for the task of deciding if an air bag should be deployed during a vehicle collision. Further, the seat position sensor is also preferably already present in the vehicle for use in conjunction with a power seat moving device.

In accordance with the present invention, the occupant weight sensor and the seat position sensor each send a signal to a controller. Further, an occupant selected set temperature (Tₛₑₜ) is transmitted to the controller. The controller then calculates a fitness factor, which is a metric that combines the occupant weight and seat position into a single measurement to judge the occupant's fitness level. Depending on the value of the fitness factor, a corrected set temperature (Tₛₑₜ′) may be used. The corrected set temperature (Tₛₑₜ′), which is based upon the fitness factor and the set temperature (Tₛₑₜ), is then employed by the controller to calculate a temperature at outlet (TAO). The TAO is then used to control operation of an HVAC system. Alternatively, the fitness factor is utilized to scale the temperature at outlet (TAO), which is then employed by the controller to control operation of the HVAC system.

### BRIEF DESCRIPTION OF THE DRAWINGS

These and further features of the invention will be apparent with reference to the following description and drawings, wherein:

FIG. 1 is a side view of a vehicle with a climate control system installed;

FIG. 2 is a perspective view of the vehicle of FIG. 1;

FIG. 3 is front view of a dashboard of the vehicle;

FIG. 4 is a schematic diagram illustrating the relationship between various components of the climate control system of the present invention;

FIG. 5 is a flowchart illustrating a method according to the present invention; and

FIG. 6 is a flowchart illustrating an alternate method according to the present invention.

### DETAILED DESCRIPTION OF THE PREFERRED EMBODIMENTS

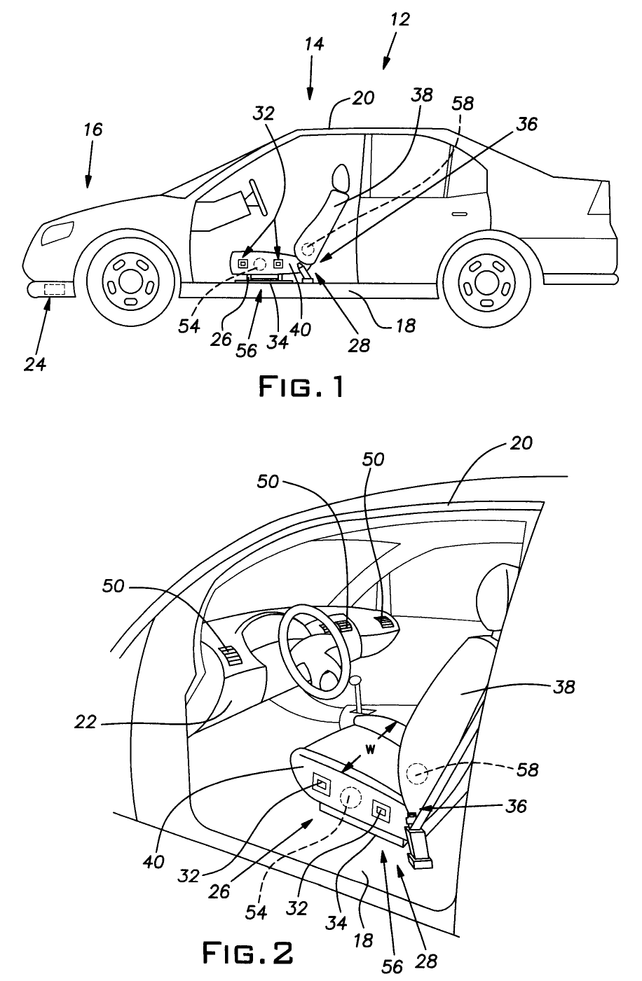

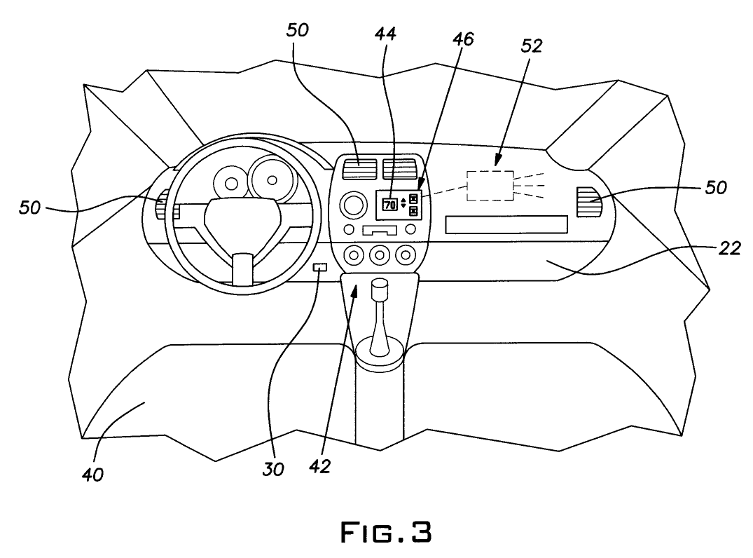

With reference to FIGS. 1-4, a climate control system 10 for a vehicle 12 according to the present invention is shown. The vehicle 12 includes a cabin 14 and an engine compartment 16. A floor 18, a roof 20, and a dashboard 22 are inside of the cabin 14. An ambient temperature sensor 24 is located near the engine compartment 16. A vehicle door has been removed for ease of viewing the cabin 14. Rails 26 that support a seat 28 are disposed on the floor, while a cabin temperature sensor 30 is located on the dashboard 22. Seat controls 32, seat slides 34, and a pivot point 36 are disposed on or around the seat 28. The seat 28 further includes a seat back 38 and a seat cushion 40.

An HVAC system 42 includes a temperature display 44, an input device 46 for changing a set temperature (Tₛₑₜ), and outlets 50 for dispersing conditioned air. Although not illustrated, the HVAC system 42 also includes a compressor, an evaporator, a dryer, a heater core, fans, and ducts, as is well known in the art. While the outlets 50 are only illustrated as being on a vertical surface of the dashboard 22, it is considered apparent that other locations in the cabin 14 offer suitable sites for placement.

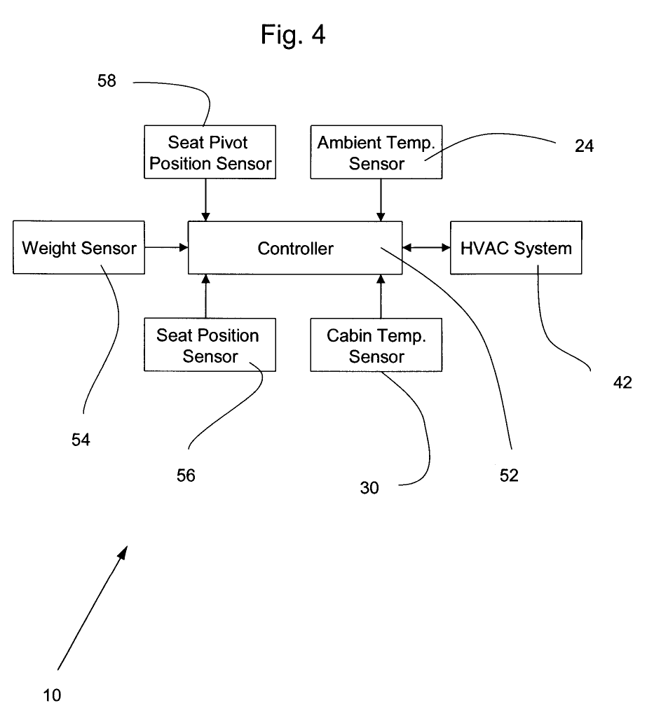

Located behind the dashboard 22 is a controller 52. As specifically shown in FIG. 4, the ambient temperature sensor 24, the cabin temperature sensor 30, the HVAC system 42, a weight sensor 54, a seat position sensor 56, and, optionally, a seat pivot position sensor 58 are electrically connected to the controller 52. However, other means such as wireless or fiber-optic communication to connect the controller 52 with the ambient temperature sensor 24, the cabin temperature sensor 30, the HVAC system 42, the weight sensor 54, the seat position sensor 56, and the seat pivot position sensor 58 is also possible and contemplated.

The floor 18 is located on a generally horizontal plane and extends in forward, rearward, left, and right directions in the cabin 14 as illustrated in FIG. 2. The rails 26 are disposed on the floor 18 and slidably restrict movement of the seat slides 34, and hence the seat 28. The seat slides 34 extend upward from the rails 26 and are attached to the seat 28. The seat 28 is movable in the forward/rearward direction (e.g. toward and away from the engine compartment 16). While not apparent from the drawings, the seat 28 may also be movable in a height direction (e.g. toward and away from the roof 20).

The seat controls 32 are preferably located on a side of the seat 28. However, the seat controls 32 may instead be located in a variety of other locations. For example, the seat controls 32 could alternatively be disposed on the dashboard 22. The seat controls 32 provide signals to a power seat moving device (not shown) that moves the seat cushion 40, and hence the seat 28, in the forward/rearward direction. Based upon the signals received from the seat controls 32, the power seat moving device can also move the seat cushion 40, and hence the seat 28, in the height direction as previously disclosed. Further, the seat controls 32 can signal the power seat moving device to pivot the seat back 38 about the pivot point 36. The power seat moving device is comprised of an electric motor(s) and gears that provide the required force to move the seat 28 in the forward, rearward, up, down and angular positions as desired by the occupant. The power seat moving device is commercially available and not central to the present invention. Alternatively, a manual seat moving device could be used to provide a similar range of motion for the seat 28.

The ambient temperature sensor 24 may be disposed at a relatively forward position on the vehicle 12, if desired. Naturally, it is known in the art that various locations for the ambient temperature sensor 24 may be selected, and therefore the present invention is not limited to the currently preferred ambient temperature sensor position illustrated herein.

An occupant seating volume is defined by: the seat cushion 40 and the roof 20 in the height direction, the dashboard 22 and the seat back 38 in the forward/rearward direction, and by outer edges of the seat 28 formed by the dimension labeled W in a width direction. The W dimension is the width of the seat 28. The occupant seating volume is a measurement of the maximum volume that the occupant could occupy in the cabin 14.

The weight sensor 54 and the seat position sensors 56, 58 are also included near the seat 28. Preferably, the weight sensor 54 is situated near the seat slides 34. However, the weight sensor 54 may alternatively be located in the seat cushion 40, as is illustrated in FIGS. 1-2. The seat position sensor 56 is disposed in the rails 26 and determines the position of the seat 28 in the height and forward/rearward directions. However, any location that allows the position of the seat 28 to be ascertained by the seat position sensor 56 is contemplated and possible.

In an alternative embodiment, the seat pivot position sensor 58 is installed near the pivot point 36. With this alternative embodiment, the seat pivot position sensor 58 can sense the angular position of the seat back 38 of the seat 28. It should be noted that the seat position sensors 56, 58 are preferably already present in the vehicle 12 for use in conjunction with the power seat moving device (not shown) to move the seat 28 in the forward/rearward, height, and angular directions.

The forward/rearward and height seat positions, and preferably the angular seat position, are transmitted to the controller 52 from the seat position sensors 56, 58. As the seat width W is fixed, the controller 52 is then able to determine the occupant seating volume. Further, the weight sensor 54 transmits the occupant's weight to the controller 52.

By knowing the position of the seat 28, the occupant's general size is known. For example, an occupant of a large stature would typically position the seat 28 in a more rearward position (e.g. away from the engine compartment 16) than an occupant of a small stature. Once the seat position and occupant weight are received by the controller 52, a fitness factor can be determined.

The fitness factor is a metric that allows the occupant's size, obtained from the seat position sensors 56, 58, and the occupant's weight, obtained from the weight sensor 54, to be combined into a single value. Then, the fitness factor can be used to judge whether the occupant is of a high fitness factor, and hence a high fitness level, or if the occupant is of a low fitness factor, and hence a low fitness level. Usually, an occupant with a low fitness factor prefers a cooler cabin 14. Typically, when the fitness factor is low, the HVAC system 42 provides air to the cabin 14 that is less than the set temperature (Tₛₑₜ). For example, if the set temperature (Tₛₑₜ) was 72° F. and an occupant with a low fitness factor was present in the cabin 14, the HVAC system 42 would operate as though the set temperature (Tₛₑₜ) was 68° F. Alternatively, if the occupant has a high fitness factor, the HVAC system 42 would operate as though the set temperature (Tₛₑₜ) was 74° F.

A corrected set temperature (Tₛₑₜ′) is utilized in the previous example to operate the HVAC system 42 when the occupant with the low fitness factor was present in the cabin 14. Based upon the set temperature (Tₛₑₜ) and the fitness factor, the corrected set temperature (Tₛₑₜ′) is preferably derived from a lookup table stored in the controller 52. The corrected set temperature (Tₛₑₜ′) is used by to the controller 52 to calculate a temperature at outlet (TAO). The TAO is then used by the controller 52 to control the HVAC system 42. The corrected set temperature (Tₛₑₜ′) may be shown on the display 44. Alternatively, the set temperature (Tₛₑₜ) may be displayed on the display 44.

According to the present invention, the HVAC system 42 can be controlled by the controller 52 by using either the temperature at outlet (TAO) modified by the fitness factor, or the TAO using the corrected set temperature (Tₛₑₜ′). In further accordance with the present invention, the calculated fitness factor may be compared to either a fitness factor that is from a previous occupant, or compared to a predetermined median fitness factor. For example, if the calculated fitness factor is greater than the fitness factor of the previous occupant or if the calculated fitness factor is greater than the predetermined median fitness factor, the set temperature will be corrected (Tₛₑₜ40 ) or the TAO will be scaled, as discussed previously, so that the cabin temperature will be warmer than if the fitness factor was not utilized to control the HVAC system 42. Alternatively, if the calculated fitness factor is less than the fitness factor of the previous occupant or if the calculated fitness factor is less than the predetermined median fitness factor, the set temperature will be corrected (Tₛₑₜ′) or the TAO will be scaled, as discussed previously, so that the cabin temperature will be cooler than if the fitness factor was not utilized to control the HVAC system 42.

In this regard it is noted that the TAO is a calculated value of outlet temperature that is well known in the art and may be based upon a number of parameters, such as sensed cabin temperature, solar load, ambient temperature, etc., but is primarily based upon the set temperature (Tₛₑₜ) input by the occupant. It is also known in the art that the calculated outlet temperature TAO is commonly used in the automatic mode of operation to control fan speed and outlet selection and, as will be seen in the following, this control setting is modified in some portions of the controller 52 to provide for improved response.

The TAO can be directly or indirectly modified by the fitness factor. For example, the fitness factor can directly modify the TAO by using a scaling factor that is based upon either the predetermined median fitness factor or the prior occupant's fitness factor, as noted hereinbefore. The fitness factor indirectly modifies the TAO when the TAO is calculated based upon the corrected set temperature (Tₛₑₜ′) instead of the user-input set temperature (Tₛₑₜ). For example, as will be discussed hereinafter, the set temperature (Tₛₑₜ) is modified to the corrected set temperature (Tₛₑₜ′) based upon the calculated fitness factor. The corrected set temperature (Tₛₑₜ′) is then used in the calculation of the TAO.

By controlling the HVAC system 42 based upon the TAO utilizing the fitness factor, the occupant is exposed to conditioned air that will provide the perception that the cabin temperature is equal to the set temperature (Tₛₑₜ). However, the temperature of the air leaving the outlets 50 may be warmer or cooler than the set temperature (Tₛₑₜ). This ensures that the occupant feels comfortable. It is noted that when the HVAC system 42 is being controlled based upon the TAO that has been directly modified by the fitness factor, the set temperature (Tₛₑₜ) is preferably shown on the temperature display 44. Alternatively, the corrected set temperature (Tₛₑₜ′) may be displayed.

Generally, an occupant with large stature and large weight would require different cabin air conditions in the vehicle 12 to feel comfortable than an occupant of small stature and small weight. For example, the occupant with large weight and stature would typically desire cooler cabin air conditions in the vehicle 12. The controller 52 utilizes the position of the seat 28 and occupant weight data, obtained from the weight sensor 54 and the seat position sensor 56 and pivot position sensor 58 respectively, to control the HVAC system 42 based upon the TAO.

In the embodiments in which the calculated fitness factor is compared to a prior occupant's fitness factor, a first occupant enters the vehicle 12 and is seated in the seat 28. The seat 28 is positioned to a desired first position by the first occupant using the seat controls 32. The seat position and weight of the first occupant as sensed by the seat position sensors 56, 58 and the weight sensor 54 are sent to the controller 52. The controller 52 calculates a first fitness factor for the first occupant. In addition, the first occupant selects the set temperature (Tₛₑₜ) with the input device 46. The TAO is calculated, and the HVAC system 42 then discharges conditioned air from the outlets 50 to adjust the cabin air conditions. After arriving at a desired destination, the first occupant exits the vehicle 12. Later, a second occupant enters the vehicle 12. The second occupant would then adjust the seat 28 to a second position using the seat controls 32. A weight of the second occupant and a second seat position would be transmitted to the controller 52 from the weight sensor 54 and the seat position sensor 56, and optionally the seat pivot position sensor 58. A second fitness factor would then be calculated and used to control the HVAC system 42 (by either obtaining a corrected set temperature (Tₛₑₜ′), which is a factor used in calculating TAO, or by factoring directly into the temperature at outlet (TAO) equation), to provide a comfortable cabin air conditions to the second occupant. As mentioned hereinbefore, the temperature display 44 may show either the set temperature (Tₛₑₜ) or the corrected set temperature (Tₛₑₜ′). Control of the HVAC system 42 would be accomplished without the second occupant needing to adjust the set temperature (Tₛₑₜ) with the input device 46 to account for a difference in fitness level from the first occupant. The above described situation could be repeated again and again with subsequent occupants and similar success in each trial.

In the preceding example, if the fitness factor for the second occupant was higher than that of the first occupant, the TAO calculation would result in the air that is coming from the outlets 50 being warmer, either in a heating or cooling mode, as compared to if the first occupant was in the vehicle 12. Alternatively, if the fitness factor for the second occupant was lower than that of the first occupant, the TAO calculation would result in the air that is coming from the outlets 50 being cooler, as compared to if the first occupant was in the vehicle 12.

In an alternate embodiment, the calculated fitness factor can be compared to a predetermined median fitness factor, preferably determined from a second lookup table stored in the controller 52. The predetermined median fitness factor is experimentally derived and is equal to a fitness factor that would not require changes to the set temperature (Tₛₑₜ) or the TAO in order for the occupant to feel comfortable (i.e. a base or predetermined median fitness factor that serves as a standard against which all occupants are compared). If the occupant's calculated fitness factor is greater than the predetermined median fitness factor, the set temperature (Tₛₑₜ) would be adjusted to a corrected set temperature (Tₛₑₜ′) that is higher than set temperature (Tₛₑₜ) thereby resulting in a higher calculated TAO. On the other hand, if the calculated fitness factor is less than the predetermined median fitness factor, the set temperature (Tₛₑₜ) would be adjusted to a corrected set temperature (Tₛₑₜ′) that is lower than the set temperature (Tₛₑₜ), thereby resulting in a lower calculated TAO.

Comparing the calculated fitness factor to the predetermined median fitness factor can also be used to directly modify the TAO. For example, if the calculated fitness factor is greater than the predetermined median fitness factor, the TAO may be scaled to be higher than if the set temperature (Tₛₑₜ) were used to determine the TAO. On the other hand, if the calculated fitness factor is less than the predetermined median fitness factor, the TAO may be scaled to be lower than if the set temperature (Tₛₑₜ) were used to determine the TAO.

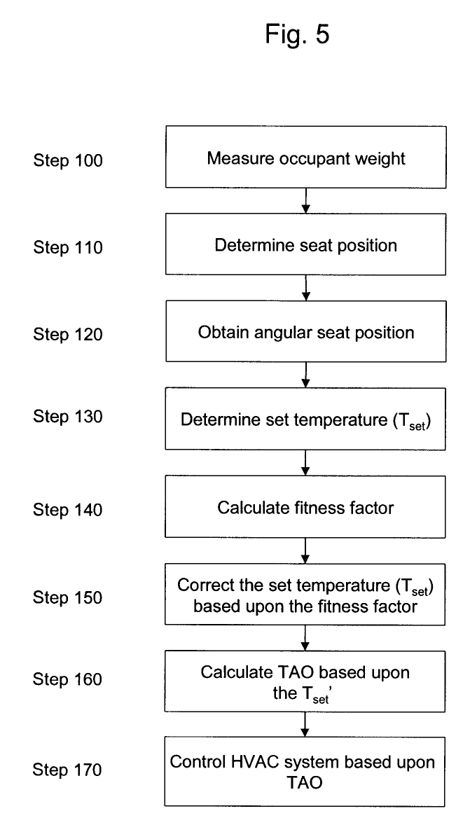

A method of using the present invention is illustrated in FIG. 5. In Step 100, the occupant weight is measured. Then, the seat position is determined (Step 110). The angular seat position is also obtained (Step 120). In Step 130, the set temperature (Tₛₑₜ) is determined. Also, the fitness factor is calculated (Step 140). Next, the set temperature (Tₛₑₜ) is corrected to the corrected set temperature (Tₛₑₜ′), based on the fitness factor (Step 150). Correction of the set temperature (Tₛₑₜ) is based upon either comparing the calculated fitness factor to the previous occupant's fitness factor or to the predetermined median fitness factor. In Step 160, the TAO is calculated based upon the corrected set temperature (Tₛₑₜ′). Then, the controller controls the HVAC system based upon the TAO (Step 170).

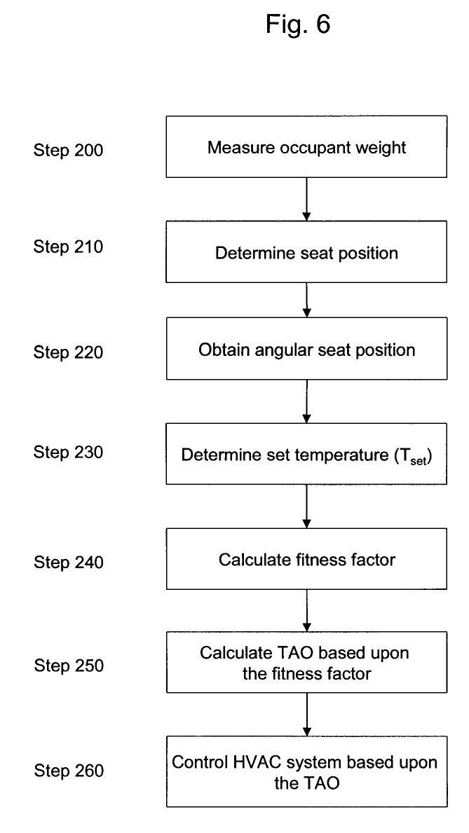

FIG. 6 illustrates an alternate method according to the present invention. Steps 200-240 are identical to Steps 100-140 illustrated in FIG. 5, and therefore will not be discussed further. However, in Step 250 of FIG. 6, the temperature at outlet (TAO) is determined based upon the fitness factor. The TAO is scaled by comparing the calculated fitness factor to either the previous occupant's fitness factor and the set temperature (Tₛₑₜ), or to the predetermined median fitness factor. Then, the controller controls the HVAC system based upon the TAO (Step 260).

When different occupants use the vehicle 12 at different times, the fitness factor allows for convenient automatic control of the HVAC system 42. Since the climate control system 10 automatically adjusts the cabin air conditions in the vehicle 12 for subsequent occupants, a comfortable air environment is enjoyed by the occupants without the need to constantly adjust the set temperature (Tₛₑₜ). It is expected that the present invention will provide users of different fitness levels with a common comfort level.

In addition, the present invention improves the air environment even when only one occupant uses the vehicle 12. For example, the present invention can automatically adjust the cabin conditions by adjusting the TAO (either directly or indirectly) based upon how the calculated fitness factor compares to the predetermined median fitness factor so that the occupant's physical fitness or shape is factored into the determination of what would be the most comfortable environment.

As described hereinabove, the present invention solves many problems associated with previous type devices. However, it will be appreciated that various changes in the details, materials and arrangements of parts, which have been herein described and illustrated in order to explain the nature of the invention, may be made by those skilled in the art without departing from the principle and scope of the invention, as expressed in the appended claims.

What is claimed is:

1. An HVAC control system for a vehicle with a seat, comprising:
an occupant weight sensor that measures a weight of an occupant;
a seat position sensor that determines a position of the seat in which the occupant is seated; and
a controller that calculates a fitness factor based upon the sensed weight and the sensed seat position, wherein the fitness factor is a calculated value for comparing relative fitness of occupants, and wherein the controller operates an HVAC system to adjust cabin air conditions based upon the calculated fitness factor.

2. The HVAC control system of claim 1, wherein cabin air conditions include air temperature and humidity.

3. The HVAC control system of claim 1, wherein the seat position sensor senses a forward/rearward position of the seat.

4. The HVAC control system of claim 1, wherein the seat position sensor senses a height position of the seat.

5. The HVAC control system of claim 1, wherein the seat position sensor senses an angular position of a seat back of the seat.

6. The HVAC control system of claim 1, wherein the controller operates the HVAC system to adjust cabin air conditions based upon the calculated fitness factor as compared to either a predetermined median fitness factor or to a previously calculated fitness factor from a previous occupant.

7. A method for controlling a vehicle HVAC system to automatically adjust vehicle cabin air conditions based upon physical fitness of an occupant, comprising the steps of:
sensing a seat position;
sensing a weight of the occupant;
calculating a fitness factor based upon the sensed seat position and the sensed occupant weight;
determining a corrected set temperature based upon the fitness factor and a set temperature supplied by the occupant;
calculating a temperature at outlet based upon the corrected set temperature; and
controlling the HVAC system based upon the corrected set temperature.

8. The method for controlling the vehicle HVAC system to automatically adjust the vehicle cabin air conditions according to claim 7, wherein the step of sensing the seat position includes sensing a forward/rearward position of the seat.

9. The method for controlling the vehicle HVAC system to automatically adjust the vehicle cabin air conditions according to claim 7, wherein the step of sensing the seat position includes sensing an angular position of a seat back of the seat.

10. The method for controlling the vehicle HVAC system to automatically adjust the vehicle cabin air conditions according to claim 7, wherein the step of determining the corrected set temperature is further based upon comparing the calculated fitness factor to a predetermined median fitness factor.

11. The method for controlling the vehicle HVAC system to automatically adjust the vehicle cabin air conditions according to claim 7, wherein the step of determining the corrected set temperature is further based upon comparing the calculated fitness factor to a prior fitness factor from a prior occupant.

12. A method for controlling a vehicle HVAC system to automatically adjust vehicle cabin air conditions based upon physical fitness of an occupant, comprising the steps of:
sensing a seat position;
sensing a weight of an occupant;
calculating a fitness factor based upon the sensed seat position and the sensed occupant weight;
determining a temperature at outlet based upon the fitness factor and a set temperature supplied by the occupant; and
controlling an HVAC system based upon the determined temperature at outlet.

13. The method for controlling the vehicle HVAC system to automatically adjust the vehicle cabin air conditions according to claim 12, wherein the step of sensing the seat position includes sensing a forward/rearward position of the seat.

14. The method for controlling the vehicle HVAC system to automatically adjust the vehicle cabin air conditions according to claim 12, wherein the step of sensing the seat position includes sensing an angular position of a seat back of the seat.

15. The method for controlling the vehicle HVAC system to automatically adjust the vehicle cabin air conditions according to claim 12, wherein the step of determining the temperature at outlet is further based upon comparing the calculated fitness factor to a predetermined median fitness factor.

16. The method for controlling the vehicle HVAC system to automatically adjust the vehicle cabin air conditions according to claim 12, wherein the step of determining the temperature at outlet is further based upon comparing the calculated fitness factor to a prior fitness factor from a prior occupant.
